(19) United States
(12) Patent Application Publication
(10) Pub. No.: US 2024/0419412 A1
(43) Pub. Date: Dec. 19, 2024

(54) USER INTERFACE SUPPORT MODULE AND METHOD OF USE

(71) Applicant: 1370092 Ontario Ltd., Waterdown (CA)

(72) Inventor: Nicole Serena, Waterdown (CA)

(73) Assignee: 1370092 Ontario Ltd., Waterdown (CA)

(21) Appl. No.: 18/208,995

(22) Filed: Jun. 13, 2023

(51) Int. Cl. G06F 8/38; G06F 9/451

(52) U.S. Cl. CPC G06F 8/38; G06F 9/451

(57) ABSTRACT

A user interface support module, the user interface support module comprising a processor and a memory communicatively connected to the processor, the memory containing instructions configuring the processor to receive an attribute cluster relating to one or more treatment recipients, sort the attribute cluster into one or more support categorizations, generate one or more support modules as a function of the sorting, wherein at least one of the one or more support modules is generated using a support machine learning model, construct a user interface data structure, wherein the user interface data structure comprises the one or more support modules and alter a graphical user interface as a function of the user interface data structure.

### FIELD OF THE INVENTION

The present invention generally relates to the field of graphical user interfaces. More particularly, the present invention relates to a user interface support module.

### BACKGROUND

Current user interfaces used to generate support modules are lacking and do not manipulate data suitable for tailored and individualized growth modules.

### SUMMARY OF THE DISCLOSURE

In an aspect, a user interface support module is described. The user interface support module includes a processor and a memory communicatively connected to the processor. The memory contains instructions configuring the processor to receive an attribute cluster relating to one or more treatment recipients and sort the attribute cluster into one or more support categorizations. The memory further contains instructions configuring the processor to generate one or more support modules as a function of the sorting, wherein at least one of the one or more support modules is generated using a support machine learning model, construct a user interface data structure, wherein the user interface data structure comprises the one or more support modules and alter a graphical user interface as a function of the user interface data structure.

In another aspect a method of providing support modules through a user interface is described. The method includes receiving, by at least a processor, an attribute cluster relating to one or more treatment recipients, sorting, by at least the processor, the attribute cluster into one or more support categorizations, generating, by the at least a processor, one or more support modules as a function of the sorting, wherein at least one of the one or more support modules is generated as a function of a support machine learning model, constructing, by the at least a processor, a user interface data structure, wherein the user interface data structure includes the one or more support modules, transmitting, by the at least a processor, the user interface data structure to a graphical user interface and altering, by the at least a processor, a graphical user interface as a function of the user interface data structure.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of a user interface support module;

FIG. 2 is an exemplary embodiment of a graphical user interface in accordance with this disclosure;

FIG. 3 is a block diagram of exemplary embodiment of a machine learning module;

FIG. 4 is a diagram of an exemplary embodiment of a neural network;

FIG. 5 is a block diagram of an exemplary embodiment of a node;

FIG. 6 is a graph illustrating an exemplary relationship between fuzzy sets;

FIG. 7 is a flow diagram illustrating an exemplary embodiment of a method for providing support modules through a user interface; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for user interface support modules. In an aspect, user interface support modules includes a processor and a memory. In another aspect, user interface support modules is configured to generate one or more support modules.

Aspects of the present disclosure can be used to generate support modules and visually display them through a graphical user interface. Aspects of this disclosure further allows for multiple support modules wherein each support module may be interacted with. Exemplary embodiments illustrating aspects of the present disclosure are described below in the context of several specific examples.

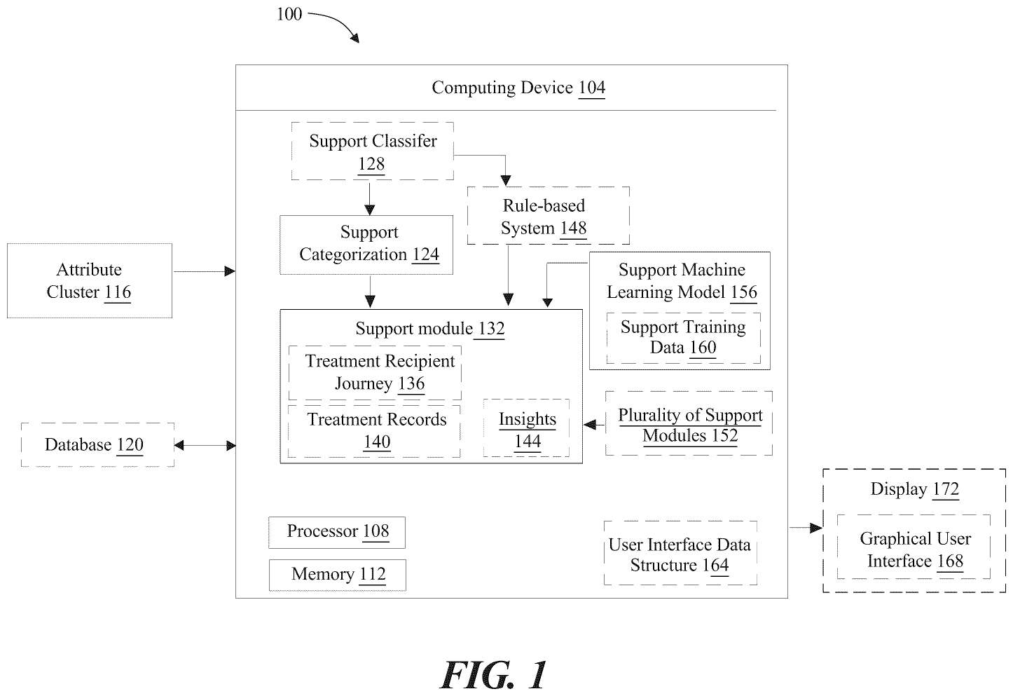

With continued reference to FIG. 1, user interface support module 100 includes a computing device 104. User interface support module 100 includes a processor 108. Processor 108 may include, without limitation, any processor 108 described in this disclosure. Processor 108 may be included in computing device 104. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device 104 operating independently or may include two or more computing devices operating in concert, in parallel, sequentially or the like; two or more computing devices may be included together in a single computing device 104 or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device 104. Computing device 104 may include but is not limited to, for example, a computing device 104 or cluster of computing devices in a first location and a second computing device 104 or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device 104, which may operate in parallel, in series, redundantly, or in any other manner used for distribution of tasks or memory 112 between computing devices. Computing device 104 may be implemented, as a non-limiting example, using a “shared nothing” architecture.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 1, user interface support module 100 includes a memory 112 communicatively connected to processor 108. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device 104. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 108 is configured to receive an attribute cluster 116 relating to one or more treatment recipients. “Attribute cluster” for the purposes of this disclosure is data relating to a group of related variables that share a common characteristic. For example, attribute cluster 116 may include a dataset containing data relating to patients taking a similar medication. A “Treatment recipient” for the purposes of this disclosure is an individual involved in medical treatment. Treatment recipient may include a prospective patient such as an individual seeking medical services or a particular medical treatment. Treatment recipient may further include an individual currently receiving a particular medication and/or receiving medical treatment. Treatment recipient may further include an individual who has previously sought medical treatment and/or who has received a particular medication.

With continued reference to FIG. 1, attribute cluster 116 may include medical data relating to one or more treatment recipients. “Medical data” for the purposes of this disclosure is any information relating to the health of a treatment recipient. Medical data may include a recipient's age, height, medical history (e.g., history of illnesses, history of medications taken, family medical history, previous medical insurances used, genetic factors of the individual that may contribute to a particular illness, and the like). In some cases, medical data may further include recent and/or future medical visits, medications prescribed, medications ingested, side effect of a particular medication, effects of a particular medication (e.g. the patients illness progressed or regressed), procedures performed, procedures planned for the recipient, cost of a particular medication, the recipient's co-pay with respect to a particular medication and the like. Medical data may further include the type of medication ingested, the dosage, the frequency of the dosage, side effects associated with one or more medications, a recipient's change in health as a result of taking the one or more medications and the like. In some cases, medical data may include any information relating to a treatment recipient who is involved in a clinical trial.

With continued reference to FIG. 1, attribute cluster 116 may further include basic background information of one or more treatment recipients. This may include but is not limited to, geographical location of the recipients, recipient's financial status (e.g. cash on hand, income, debt, dependents of the recipients, any information found on a tax return and the like). basic background information may further include a recipient's access to transportation such as access to a car, a public bus and the like. Basic background information may further include the mobility of a treatment recipient, such as the ability to walk or to travel short distances without transportation. Basic background information may further include the mental capacity of the recipient, such as the mental capacity to administer medication on their own, capacity to understand their medical conditions and the like. In some cases, attribute cluster 116 may further include any physicians that have treated the patient, pharmacies that have dispersed medication to the patient, distributors responsible for the disbursement of the medication and the like. In some cases, attribute cluster 116 may further include any information necessary to make one or more determinations about a recipient's medical status and their access to medications.

With continued reference to FIG. 1, attribute cluster 116 may further include multiple similar elements categorized by date. For example, attribute cluster 116 may include information relating to a dosage taken on a first date, a dosage taken on a second date and the like. In some cases, attribute cluster 116 may include the health of a treatment recipient over a given particular timeframe such as every week over a span of a month or a year. In some cases, attribute cluster 116 may include the health of a patient on a first date, the health of a patient on a second date and the like. In some cases, categorizations by date may allow processor 108 to make determinations based on a given period of time. For example, processor 108 may make a determination that a treatment recipient's health increased over a particular period or decreased over the particular period.

With continued reference to FIG. 1, attribute cluster 116 may be received by processor 108 via user input. For example, and without limitation, the user or a third party may manually input attribute cluster 116 using a user interface of computing device 104 or a remote device, such as for example, a smartphone or laptop. In some cases attribute cluster 116 may be received through a graphical user interface as described in further detail below. In some cases, user interface may include comment boxes in which a user may enter information relating to one or more recipients wherein attribute cluster 116 may include the information inputted by the user. “User” for the purposes of this disclosure is any person or entity who may benefit from the generation of support modules 132 as described below. User may include a medical professional such as a physician, a pharmacist, a dentist, a health coach and the like. User may further include an individual associated with an entity, wherein the entity may have an interest in the generation of one or more support modules 132. “entity” is an organization comprised of one or more persons with a specific purpose. An entity may include a corporation, organization, business, group one or more persons, and the like. In some cases, entity may include a health insurance company, a medication manufacturer, a medication distributor, a pharmacy or chain of pharmacies, a company specializing in the research and development of medications, and the like. In some cases, receiving attribute cluster 116 may include receiving a digital document and/or spreadsheet. The digital spreadsheet may include the names of the recipients and any corresponding information categorized in a series of rows or columns. For example, the spreadsheet may include a first row wherein the first column may include the name of the recipient, the second column may include the age of the recipient and the like. In some cases, each cell within the spreadsheet may be representative of an element within attribute cluster 116. In some cases receiving attribute cluster 116 may include receiving digital documents, such as medical records pertaining to one or more treatment recipients, medical history records pertaining to one or more treatment recipients and the like. In some cases, receiving attribute cluster 116 may further include receiving information from one or more treatment recipients. In some cases treatment recipients may be prompted to input corresponding information about themselves. In some cases, one or more treatment recipients may interact with a user interface such as a user interface as describe below, wherein the treatment recipients may be tasked to answer one or more questions relating to the recipients' current medical status and the like. This may include but is not limited to questions such as “what is your address?”, “please indicate the frequency and dosage of the medication you are currently taking.”, and the like. In some cases, retrieving attribute cluster 116 may further include retrieving attribute cluster 116 from a database.

Still referring to FIG. 1, user interface support module 100 may include a database. Database 120 may be implemented, without limitation, as a relational database, a key-value retrieval database such as a NOSQL database, or any other format or structure for use as database 120 that a person skilled in the art would recognize as suitable upon review of the entirety of this disclosure. Database 120 may alternatively or additionally be implemented using a distributed data storage protocol and/or data structure, such as a distributed hash table or the like. Database 120 may include a plurality of data entries and/or records as described above. Data entries in database 120 may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database 120 may store, retrieve, organize, and/or reflect data and/or records.

With continued reference to FIG. 1, attribute cluster 116 may include data from files or documents that have been converted in machine-encoded test using an optical character reader (OCR). For example, a user may input digital records and/or scanned physical documents that have been converted to digital documents, wherein attribute cluster 116 may include data that have bene converted into machine readable text. In some embodiments, optical character recognition or optical character reader (OCR) includes automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from the background of the image component. In some cases, binarization may be required for example if an employed OCR algorithm only works on binary images. In some cases, a line removal process may include the removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process will include an OCR algorithm. Exemplary OCR algorithms include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

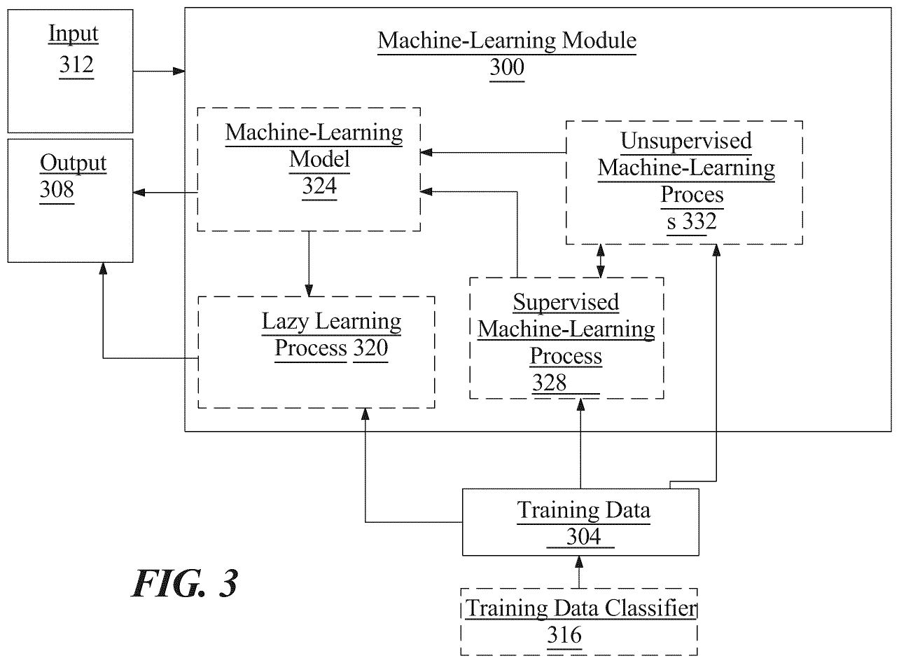

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 3-6. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. The second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 3, 4, and 5.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

In some cases, attribute cluster 116 may be retrieved using a web crawler such as a web crawler as described below. The web crawler may be configured to parse through websites and retrieve elements associated with attribute cluster. Web crawler is described in further detail below.

With continued reference to FIG. 1, processor 108 is configured to sort the attribute cluster 116 into one or more support categorizations. “Sort” for the purposes of this disclosure refers to the process of assigning elements within attribute cluster 116 to one or more categories. For example, elements within attribute cluster 116 containing information relating to the age of one or more recipients may be sorted and assigned to an age category. In another non limiting example, information relating to a particular medication and/or the dosage of a medication may be assigned to a medication or dosage category. “Support categorization” for the purposes of this disclosure is one or more groupings of information wherein each grouping may be used to make a determination about elements within attribute cluster 116. Support categorization 124 may include groupings such as age, gender, height, weight, particular medication taken, cost of a particular medication, co-pay of a particular medications, side effects of a particular medication, distributors of a particular medication, availability of a particular medication and the like. In some cases, support categorization 124 may include elements of attribute cluster 116 as described above wherein each support categorization 124 may include a similar element associated with one or more treatment recipients. For example, support categorization 124 may include the age of one or more patients sorted into one category, the medication taken by one or more patients sorted into another category and the like. In some cases, each support categorization 124 may be representative of a particular column within a spread sheet as described above. In some cases, support categorization 124 may include individual elements and/or groupings of data within attribute cluster 116 necessary to determine patient safety, financial safety, regulatory risk, risk management, and the like. In some cases, support categorization 124 may include individual elements and/or groupings of data wherein each grouping may be used to determine one or more support modules 132 as described below.

With continued reference to FIG. 1, sorting attribute cluster 116 into one or more support categorizations may include classifying the attribute cluster 116 to one or more support categorizations using a support classifier 128. For example, support classifier 128 may be configured to identify elements within attribute cluster 116 and classify them to one or more support categorizations. In a non-limiting embodiment, processor 108 may receive one or more documents within attribute cluster 116 containing information relating to one or more recipients and classify elements of attribute cluster 116 to one or more support categorizations. In some cases, elements within attribute cluster 116 may be classified to one or more support categorizations using fuzzy sets as described below.

With continued reference to FIG. 1, A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. Classifiers as described throughout this disclosure may be configured to output at least a datum that labels or otherwise identifies a set of data that are clustered together, found to be close under a distance metric as described below, or the like. In some cases, processor 108 may generate, and train support classifier 128 configured to receive attribute cluster 116 and output labels associated with one or more support categorizations. Processor 108 and/or another device may generate a classifier using a classification algorithm, defined as a process whereby a computing device 104 derives a classifier from training data. In some cases support classifier 128 may use data to prioritize the order in of labels within attribute cluster 116. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. Support classifier 128 may be trained with training data correlating attribute cluster 116 or elements thereof to one or more support categorizations such as age, medications, dosage, and the like. Training data may include a plurality of attribute clusters 116 correlated to a plurality of support categorizations. In an embodiment, training data may be used to show that a particular element within attribute cluster 116 may be correlated or associated to a particular support categorization 124. Training data may be received from an external computing device, user input, and/or previous iterations of processing. Support classifier 128 may be configured to receive as input and categorize components of attribute cluster 116 to one or more support categorizations. In some cases, processor 108 and/or computing device 104 may then select any elements within attribute cluster 116 containing a similar label and/or grouping and group them together. In some cases, attribute cluster 116 may be classified using a classifier machine learning model. In some cases classifier machine learning model may be trained using training data correlating a plurality of attribute clusters 116 to a plurality of support categorizations. In an embodiment, a particular element within attribute cluster 116 may be correlated to a particular support categorization 124. In some cases, classifying attribute cluster 116 may include classifying attribute cluster 116 as a function of the classifier machine learning model. In some cases classifier training data may be generated through user input. In some cases, classifier machine learning model may be trained through user feedback wherein a user may indicate whether a particular element corresponds to a particular class. In some cases, classifier machine learning model may be trained using inputs and outputs based on previous iterations. In some cases, a user may input previous attribute cluster 116 and corresponding support categorizations wherein classifier machine learning model may be trained based on the input.

With continued reference to FIG. 1, computing device 104 and/or processor 108 may be configured to generate classifiers as described throughout this disclosure using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process for the purposes of this disclosure. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors for the purposes of this disclosure may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, processor 108 is configured to generate one or more support modules 132 as a function of the sorting. In some cases, processor 108 may generate one or more support modules 132 based on each support categorization 124. For example, a particular support module 132 may be generated based on a medication category and another support module 132 based on a dosage category. In some cases, each support module 132 may be associated to one or more support categorizations 124. “Support module,” for the purposes of this disclosure, is information relating to determinations of each grouping of elements sorted into each support categorization 124. For example, support module 132 may contain information indicating the average age of a treatment recipient based on elements sorted into a support categorization 124 related to age. In another non limiting example, a particular support module 132 may include the average cost of a medication, or the average co-pay paid for a particular medication. In a non-limiting embodiment, one or more support modules 132 may be implemented in order to heighten a degree of care for one or more treatment recipients associated with attribute cluster 116. In another non-limiting embodiment, one or more support modules 132 may be used to monitor treatment recipients and provide information in order to increase the health of one or more treatment recipients. For example, one or more support modules 132 may be used to determine the case of access of a particular medication and to provide instructions to increase the case of access. In another non limiting example, one or more support modules 132 may be used to determine the safety of a particular medication, the case of use of a particular medication and the like. In some cases, a particular support module 132 may include information relating to a treatment recipient journey 136. “Treatment recipient journey” for the purposes of this disclosure is any information relating to one or more events associated with a treatment recipient and a particular medical care being received. For example, treatment recipient journey 136 may include a sequence of events starting from an initial diagnosis of a patient all the way until a patient has concluded their treatment. In some cases, patient program journey may include determinations based on each event. In some cases, patient program journey may include information relating to patient safety, financial safety and regulatory risk of a particular medication or treatment. In some cases, processor may generate treatment recipient journey using elements within first attribute cluster. For example, processor 108 may receive one or more events associated with a treatment recipient and categorize them in a timeline of events. In some cases, processor may generate visual data such as graphs, illustrations, and the like in order to visually represent a treatment recipient's journey through a given period. The journey may include an initial diagnosis, dates of medical visits, dates of medications taken and the like. In some cases, support module 132 may further include information and/or instructions guiding a user on how to manage risks associated with the determination based on each support categorization 124. For example, support module 132 may include information on how to manage risks with respect to patient safety, financial safety and the like. In some cases, processor may generate risks by determining if a particular support categorization 124 is associated with one or more elements within attribute cluster and selecting risks and/or information from a database or a web crawler associated with the categorization. In some cases, processor may receive patient safety, financial safety and other risks from a database or generate the risks using a web crawler. In some cases, processor 108 may make determinations and calculation about particular support categorization 124 and compare them to thresholds as described in this disclosure. Processor 108 may then select risk associated with the determinations. For example, processor 108 may select a risk associated with a calculation not meeting a threshold and select a differing risk when a calculation exceeds a threshold. In some cases, one or more support modules 132 may include information relating to current pain points within first attribute cluster 116, areas of future risk, areas of improvement and opportunity and the like. In some cases, one or more support modules 132 may include assessments associated with the one or more support categorizations. For example, one or more support modules 132 may include an assessment of side effects of one or more treatment recipients, drug dosages, of one or more treatment recipients and the like. In some cases, one or more support modules 132 may include insights 144 into each support categorization 124. “Insights” for the purposes of this disclosure refer to interpretations of elements sorted within each support categorization 124. For example, support module 132 may include an interpretation that the price of a drug is too high when a support categorization 124 related to the drug indicates that one or more treatment recipients are paying higher costs associated with the drug. In some cases, processor 108 may be configured to compare elements within attribute cluster 116 to thresholds as described in this disclosure wherein exceeding a particular threshold may indicate to a user a particular insight. For example, exceeding a threshold relating to drug prices may indicate that treatment recipients on average may be paying more for medications. Similarly, a threshold may indicate an ideal time to see favorable results with respect to a particular medication wherein processor 108 may be configured to compare a treatment recipient's health progress to an ideal progress to gain an ‘insight’ into the user's health. Processor 108 may determine that the price of a particular drug is too high when comparing it to a threshold such as a threshold indicating an ideal drug price. In some cases, one or more support modules 132 may include solutions and/or steps for improvement of a particular support categorization 124. For example, support module 132 may include instructions on how to reduce the price of a drug within a particular geographic area. In some cases, support module 132 may further include reports over a particular period. For example, support module 132 may include determinations, wherein the determinations include only elements associated with a particular month. In some cases, support module 132 may include information relating to multiple months wherein each month may include a separate determination. Continuing, support module 132 may include a determination for the month of July wherein only elements associated with the month of July may be included.

With continued reference to FIG. 1, support module 132 may include ideal practices within an industry with respect to each support categorization 124. Each support module 132 may further include instructions to accomplish these best practices. In some cases, support module 132 may further include governmental regulations associated with one or more support categorizations. These governmental regulations may guide a user in understanding any regulations that may need to be followed. In some cases support module 132 may further include any information to address or fix any issues associated with one or more support categorizations.

With continued reference to FIG. 1, one or more support modules 132 may include treatment records 140. “Treatment records” for the purposes of this disclosure is an assessment of an attribute cluster. In some cases, treatment records 140 may include areas of risk and/or opportunity associated with attribute cluster 116. Processor 108 may determine area of risk using a rule-based engine wherein the presence of one or more elements may signify potential risks. For example, the presence of a particular medication may signify potential risk associated with the medication. Rule based system may include a condition such as “if X exists within attribute cluster′” and an action such as “output risks associated with X”. In some cases, processor 108 may use a lookup table to lookup risks associated with particular elements within attribute cluster 116. In some cases, processor 108 may be configured to use a web crawler to search for risks associated with a particular element. In some cases, processor may determine areas of risks by comparing a treatment recipient's dosage requirements to the treatment recipient's actual dosage admission. In some cases, processor 108 may warn a user that a particular treatment recipient is not taking medication correctly. Processor may further be configured to output risks associated with incorrect dosing. In some cases, processor 108 may compare elements within first attribute cluster to a plurality of risk thresholds. “Risk threshold” for the purposes of this disclosure is a value, that if exceed may indicate a potential issue with a treatment recipient. For example, risk threshold may include an ideal dosage requirement wherein a user may be notified if a particular treatment recipient exceeds the threshold or does not meet the threshold. Similarly, risk threshold may include an ideal distance to the nearest medical provider, wherein processor 108 may be configured to output a risk when a treatment recipient lives too far from the nearest provider in comparison to risk threshold. In some cases, processor may select elements that exceed or do not meet the requirements of risk threshold and generate opportunities to address the risk. For example, processor may be configured to generate notification to transmit to treatment recipients about proper dosing when a treatment recipient is not taking the correct dosage. Similarly, processor 108 may be configured to search up either using a web crawler or a lookup table, closer providers to a treatment recipient when the recipient's provider is quite fat. In some cases, processor 108 may be configured to look for area of opportunity by determining geographic locations that may require a particular service, determining alternative and more costs effective distributors for a particular medication and the like. In some cases, processor 108 may make determinations about attribute cluster to determine areas of opportunity such as instructions on how to lower costs, by providing alternate distributors, alternate routes and the like. In some cases, database may include a plurality of risks and opportunities associated with each risk threshold, wherein processor may be configured to select the appropriate risk and corresponding opportunity when an element within attribute cluster 116 has not met or exceed a particular risk threshold. In some cases, database may be populated by an operator of user interface support module 100. In some cases, processor may be configured to determine the cost of a particular medication and use a lookup table or a web crawler to determine alternate distributors and the like. The web crawler may be configured to parse through websites, such as the website of a medication manufacturer to determine risks associated with a medication. In some cases, treatment records 140 may be used in part of an audit process to determine one or more issues and/or risks associated with attribute cluster 116. In some cases, treatment record may be used to improve the health of one or more treatment recipients within attribute cluster 116. In some cases, support module 132 may include information helping a user to launch a support program for the treatment recipients identified within attribute cluster 116. This may include but its not limited, gaps needed to fill to provide patient access, particular services required with respect to a particular request for proposal, information and/or steps relating to the release of a drug to the market, assessment of any issues relating to a particular drug, recommendations to provide easier access to a particular drug, information relating to staff training and the like.

With continued reference to FIG. 1, one or more support modules 132 may further include templates for documents such as templates for contracting, agreements, requests for proposal, and the like. In some cases, the templates may be stored on a database and retrieved when needed. In some cases, the templates may be retrieved using a web crawler wherein the web crawler may be configured to parse through government websites, medical manufacturer websites and the like in order to retrieve the templates. In some cases, each template may be associated with a support categorization, wherein processor may select one or more templates based on elements that have been sorted into a particular support categorization. For example, processor 108 may select a first template, when elements within attribute cluster are sorted into a first support categorization. In addition, processor 108 may not select a second template when no elements within attribute cluster are sorted into a second support categorization. In some cases, processor 108 may be configured to populate the templates based on information found within attribute cluster 116. For example, processor 108 may populate a template with the name of an entity, address of the entity and the like. In some cases, processor 108 may populate template using web crawling wherein the web crawler may be configured to retrieve information necessary to populate the templates. In some cases, processor 108 may parse through attribute cluster and populate elements within attribute cluster to one or more template boxes. In some cases, each template box may be classified to a particular class wherein processor 108 may populate each template box with elements within attribute cluster classified to the same class. In some cases, an operator may continuously generate templates and update them to a database for users to use.

With continued reference to FIG. 1, one or more support modules may further include training courses (e.g. training regarding patient support programs, training regarding one or more support modules and the like), offloading courses and the like. In some cases, the training courses may be prerecorded videos wherein a user may select from a plurality of prerecorded videos to be trained from. In some cases, each training course may be associated with a particular support categorization wherein the presence of a particular support categorization may signify processor 108 to select a particular course. In some cases, an operator may populate a database with a plurality of information or videos relating to training courses, wherein the training courses may be selected by processor 108 for viewing based on a particular support categorization. In some cases, one or more support modules may include any and all training courses that may exist on database wherein a user may choose which videos or training courses to view. In some cases, processor 108 may prioritize particular videos associated with support categorization present within attribute cluster for a user to view. In some cases, a user may interact with an interface to select one or more training courses within a particular support module 132 for viewing.

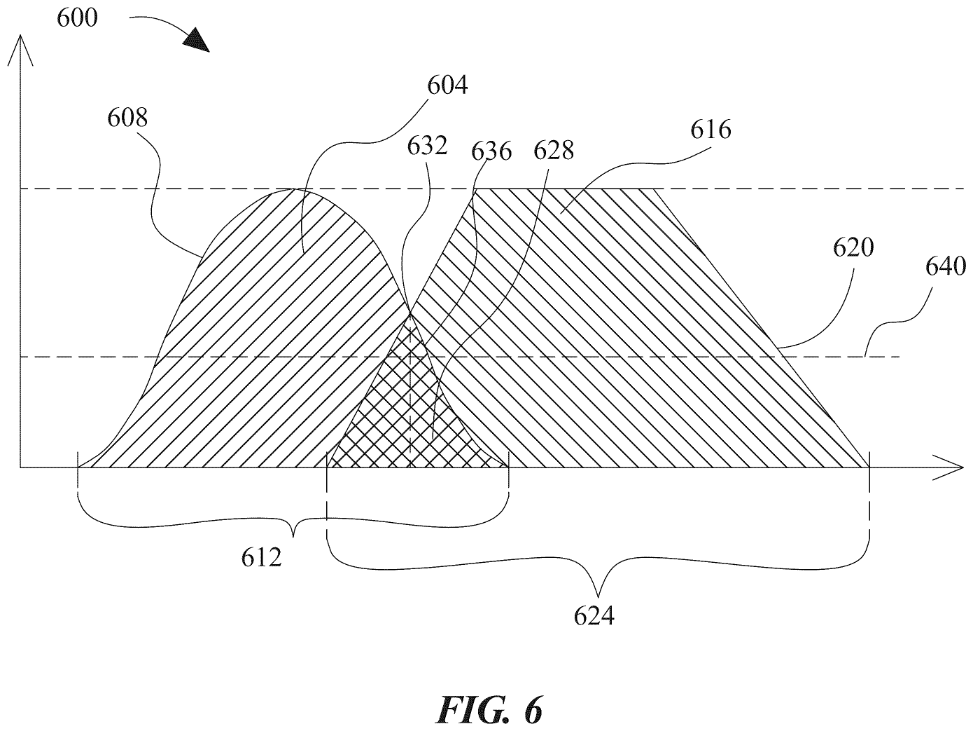

With continued reference to FIG. 1, generating one or more support modules 132 may include generating one or more support modules 132 using a rule-based system 148. “Rule-based system” also known as “rule-based engine” “rule-based engine” is a system that executes one or more rules such as, without limitations, such as a support rule in a runtime production environment. As used in this disclosure, a “support rule” is a pair including a set of conditions and a set of actions, wherein each condition within the set of conditions is a representation of a fact, an antecedent, or otherwise a pattern, and each action within the set of actions is a representation of a consequent. In a non-limiting example, support rule may include a condition of “when attribute cluster 116 contains data corresponding to x” pair with an action of “generate one or more support modules 132 associated with x.” In some embodiments, rule-based engine may execute one or more support rules on data if any conditions within one or more support rules are met. Data may include support modules 132, or any other data described in this disclosure. In some embodiments, support rule may be stored in a database 120 as described in this disclosure. Additionally, or alternatively, rule-based engine may include an inference engine to determine a match of support rule, where any or all support modules 132 may be represented as values and/or fuzzy sets for linguistic variables measuring the same, as described in more detail in FIG. 6. Inference engine may use one or more fuzzy inferencing rules, as described below in FIG. 6, to output one or more linguistic variable values and/or defuzzified values indicating match of support rule. In some cases, each rule within support rule may include a rule and a corresponding action associated with the rule. In some cases, support rule may include as rule such as “if the average copay is above a predetermined price” and a corresponding action indicating “retrieve a support module associated with high medication costs”. In some cases, inference engine may be configured to determine which rule out of a plurality of rules should be executed with respect to a particular support categorization 124. For example, inference engine may select a particular relating to case of access for a medication when the support categorization 124 relates to case of access. In some cases, processor 108 may receive an input such as one or more elements within support categorization 124 and make calculation using an arithmetic logic unit within computing device 104. In some cases, processor 108 may calculate averages of one or more elements. In some cases, processor 108 may retrieve one or more formulas from a database 120 and make calculations as a function of the formulas. In some cases, each support categorization 124 may include a predetermined formula wherein processor 108 may make calculations using elements within support categorization 124 and the corresponding formula. In some cases rule-based engine may generate one or more support modules 132 as a function of the formula. In some cases, processor 108 may receive numerical elements associated with each element wherein the numerical elements may be used to perform calculations and determinations. For example, a particular element describing that case of access of a particular for a medication might be difficult may be assigned a number associated with the difficulty. Processor 108 may then generate an average wherein the average may be representative of the average case of access of particular medication. For example, difficulty accessing a medication may be associated with a ‘10’ and easily accessing a medication may be associated with a ‘1’ wherein an average (ranging from 1-10) of multiple numerical elements may indicate how difficult it may be to access a medication. In another non limiting similar example, processor 108 may receive numerical elements associated with each element in a support categorization 124 describing side effects of a medication wherein the severity of the side effect may range on a scale of 1-10 and an average may be created. In some cases, processor 108 may use a lookup table to lookup numerical elements associated with each element within a particular support categorization 124. For example an element describing difficulty in accessing a medication may be looked to have a correlated numerical element of 7. In some cases, processor 108 may classify elements of each support categorization 124 to one or more numerical elements. Processor 108 may classify each element within a support categorization 124 to one or more numerical elements and generate an average based on the numerical elements. In some cases, processor 108 may generate one or more support modules 132 using a rule-based system 148 wherein a particular average may result in a particular action to generate or retrieve a support module 132. For example, processor 108 may generate a support module 132 that contains information guiding a user to on how to increase the access of particular medication when the particular average indicates that users on average are having a more difficult time accessing a medication. In some cases, rule-based system 148 may include a rule to retrieve or select one or more support modules 132 form a database 120 as described below. A “lookup table,” for the purposes of this disclosure, is a data structure, such as without limitation an array of data, that maps input values to output values. A lookup table may be used to replace a runtime computation with an indexing operation or the like, such as an array indexing operation. A look-up table may be configured to pre-calculate and store data in static program storage, calculated as part of a program's initialization phase or even stored in hardware in application-specific platforms. Data within the lookup table may include one or more support modules 132 associated with one or more support categorization 124 and/or one or more averages associated with one or more support categorization 124. Data within the lookup table may be received from database. In a non-limiting example, processor 108 may look up a particular support module 132 using a calculated average, wherein the average is associated with a particular support module 132 in the lookup table.

With continued reference to FIG. 1, information within one or more support modules 132 may be retrieved from a database or generated using a web crawler. In some cases, database may include a plurality of support modules wherein one or more support modules are associated with each support categorization. Processor 108 may select a particular support module that is associated with a particular support categorization when elements within attribute cluster may indicate to do so. For example, for example, processor 108 may use rule-based system as described above to select a particular support module. In some cases, processor 108 may compare elements within attribute cluster and/or elements within a particular support categorization and compare them to a plurality of thresholds as described in this disclosure. Processor 108 may generate one or more support modules as a function of the comparison. In a non-limiting example, a support module may include one or more elements within attribute cluster compared to one or more thresholds wherein support module may provide a user with information on areas that do not need meet or that exceed a particular threshold. In some cases, processor 108 may be configured to generate support modules as a function of one or more determinations. For example, a web crawler may crawl the web such as research websites, drug manufacturer websites, mapping websites and the like to generate information for use in one or more support modules 132. For example, processor 108 is configured to crawl and search for other drug distributors within an area when a drug price is too high. Similarly, processor 108 may be configured to search for side effects associated with improper dosing of medications or improper timing of consumption with medications. In some cases, a database may be populated with a plurality of support modules, wherein the modules are generated by an operator of user interface support module 100. The operator may consistently update database with new support modules and/or modify existing modules. In some cases, database may include one or more thresholds that may be used to make one or more determinations based on the sorting of attribute cluster 116. In some cases, an operator may update the thresholds described in this disclosure. In some cases, processor may

With continued reference to FIG. 1, generating one or more support modules 132 may include retrieving a plurality of support modules 152. plurality of support modules 152 may be located on a storage or database, wherein processor 108 may be configured to select one or more support modules 132 from the plurality of support modules 152 as a function of the sorting. For example, processor 108 may use a rule-based engine to select one or more support modules 132. In some cases, the plurality of support modules 152 may be generated by a user. In some cases, plurality of support modules 152 may be generated using web crawler. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. In some embodiments, computing device 104 may generate a web crawler to generate plurality of support modules 152. The web crawler may be seeded and/or trained with a reputable website, such as governmental websites, to begin the search. A web crawler may be generated by computing device 104. In some embodiments, the web crawler may be trained with information received from a user through a user interface. In some embodiments, the web crawler may be configured to generate a web query. A web query may include search criteria received from a user. For example, a user may submit a plurality of websites for the web crawler to search to extract any data suitable for support modules 132.

With continued reference to FIG. 1, generating one or more support modules 132 may include comparing attribute cluster 116 to one or more safety thresholds. A “safety threshold” is a predefined boundary used to make decisions about a particular element. For example, processor 108 may compare an element to a safety threshold wherein an action may result based on whether the element has exceeded the boundary. In some cases, processor 108 may generate one or more support modules 132 as a function of comparing attribute cluster 116 to one or more safety thresholds. For example, processor 108 may generate one or more support modules 132 if an element exceeds a particular safety threshold. In some cases, each safety threshold may be associated to a particular support categorization 124 wherein processor 108 may compare elements within support categorization 124 to a safety threshold. In some cases, processor 108 may compare an average of multiple elements within a particular support categorization 124 to a particular safety threshold. In some cases, processor 108 may use rule-based system 148 to generate one or more support modules 132 wherein a rule may include “If X average exceeds X safety threshold, select a Y support module 132”. In some cases, processor 108 may determine a deviation between a particular numerical element and a corresponding safety threshold wherein the degree of deviation may be dependent on selection of a particular support module 132. For example, a high degree of deviation may indicate one support module 132 whereas a low degree of deviation may indicate a second support module 132.

With continued reference to FIG. 1, generating one or more support modules 132 may include generating one or more support modules 132 using a support machine learning model 156. Processor 108 may use a machine learning module, such as a support machine learning module for the purposes of this disclosure, to implement one or more algorithms or generate one or more machine-learning models, such as an assessment machine learning model, to calculate at least one smart assessments. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from database, such as any database 120 described in this disclosure, or be provided by a user. In other embodiments, a machine-learning module may obtain a training set by querying a communicatively connected database 120 that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more support modules 132 corresponding to categories of data elements. As a non-limiting example, training data may include data entered in standardized forms by persons or processes, such that entry of a given data element in a given field in a form may be mapped to one or more categories. Elements in training data may be linked to categories by tags, tokens, or other data elements. A machine learning module, such as support module 132, may be used to generate support machine learning model 156 and/or any other machine learning model described herein using training data. Support machine learning model 156 may be trained by correlated inputs and outputs of training data. Training data may be data sets that have already been converted from raw data whether manually, by machine, or any other method. Support training data 160 may be stored in database. Support training data 160 may also be retrieved from database.

With continued reference to FIG. 1, in one or more embodiments, a machine-learning module may be generated using training data. Training data may include inputs and corresponding predetermined outputs so that machine-learning module may use the correlations between the provided exemplary inputs and outputs to develop an algorithm and/or relationship that then allows machine-learning module to determine its own outputs for inputs. Training data may contain correlations that a machine-learning process may use to model relationships between two or more categories of data elements. The exemplary inputs and outputs may come from database, such as any database 120 described in this disclosure, or be provided by a user such as a physician, insurance provider, and the like. In other embodiments, machine-learning module may obtain a training set by querying a communicatively connected database 120 that includes past inputs and outputs. Training data may include inputs from various types of databases, resources, and/or user inputs and outputs correlated to each of those inputs so that a machine-learning module may determine an output. Correlations may indicate causative and/or predictive links between data, which may be modeled as relationships, such as mathematical relationships, by machine-learning processes, as described in further detail below. In one or more embodiments, training data may be formatted and/or organized by categories of data elements by, for example, associating data elements with one or more support modules 132 corresponding to categories of data elements. As a non-limiting example, training data may include data entered in standardized forms by persons or processes, such that entry of a given data element in a given field in a form may be mapped to one or more categories. Elements in training data may be linked to categories by tags, tokens, or other data elements.

With continued reference to FIG. 1 generating one or more support modules 132 may include receiving support training data 160 including a plurality of attribute clusters 116 correlated to a plurality of support modules 152. For example, support training data 160 may be used to show a particular attribute cluster 116 correlated to one or more support modules 132. In an embodiment, support training data 160 may include a plurality of sorted elements within attribute cluster 116 correlated to a plurality of support modules 152. In an embodiment, elements within a particular support categorization 124 may indicate a particular support module 132. In some cases, support training data 160 may be received from a user, third party, database, external computing devices previous iterations of the processing and/or the like as described in this disclosure. In some cases, support training data 160 may include previous iterations of attribute cluster 116 and previous iterations of support module 132. In some cases, generating support module 132 further includes training support machine learning model 156 as a function of the support training data 160 and generating support module 132 as a function of the support machine learning model 156. In some cases, support training data 160 may be trained based in user input wherein user input may determine if a particular training data was accurate as a result of a previous iteration. In some cases, support training data 160 may include historical training data. “Historical training data” for the purposes of this disclosure is information relating to past actions or events associated with one or more users. In some cases, historical training data may include ideal or best practices within an industry. In some cases historical data may include support modules 132 that have been implemented by users within a particular industry. In some cases, historical training data may include previously implemented support modules 132 that provided a desirable result. In some cases, historical training data may be stored and/or retrieved from a database. In some cases, historical training data may be generated using a web crawler. The web crawler may be configured to crawl websites such as news websites, government agency websites, websites related to a particular entity and the like.

With continued reference to FIG. 1, processor 108 is further configured to construct a user interface data structure 164, wherein the user interface data structure 164 includes one or more growth modules. As used in this disclosure, “user interface data structure” is a data structure representing a specialized formatting of data on a computer configured such that the information can be effectively presented for a user interface. In some cases, user interface data structure 164 includes one or more growth modules and/or any data described in this disclosure.

With continued reference to FIG. 1, processor 108 may be configured to transmit the user interface data structure 164. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. Processor 108 may transmit the data described above to database 120 wherein the data may be accessed from database. Processor 108 may further transmit the data above to a device display or another computing device 104.

With continued reference to FIG. 1, user interface support module 100 may further include a graphical user interface 168 (GUI). For the purposes of this disclosure, a “user interface” is a means by which a user and a computer system interact. For example a user may interact with a computer system through the use of input devices and software wherein user interface may be configured to facilitate the interaction between the user and the computer system. A user interface may include graphical user interface 168, command line interface (CLI), menu-driven user interface, touch user interface, voice user interface (VUI), form-based user interface, any combination thereof and the like. In some embodiments, a user may interact with the user interface using a computing device 104 distinct from and communicatively connected to processor 108. For example, a smart phone, smart tablet, or laptop operated by the user and/or participant. A user interface may include one or more graphical locator and/or cursor facilities allowing a user to interact with graphical models and/or combinations thereof, for instance using a touchscreen, touchpad, mouse, keyboard, and/or other manual data entry device. A “graphical user interface,” as used herein, is a user interface that allows users to interact with electronic devices through visual representations. In some embodiments, GUI 168 may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface 168. Persons skilled in the art, upon reviewing the entirety of this disclosure, will be aware of various ways in which a graphical user interface 168 and/or elements thereof may be implemented and/or used as described in this disclosure.

With continued reference to FIG. 1, processor 108 is further configured to alter graphical user interface 168 as a function of the user interface data structure 164. In some cases, user interface data structure 164 may alter GUI 168 by introducing the underlying data that may be visually presented by GUI 168. In some cases, user interface data structure 164 may include information relating to GUI 168 such as one or more growth modules, interaction components and the like. In some cases, user interface data structure 164 may provide the elements to be visually presented by GUI 168. In some cases, manipulation of one or more interaction components may modify the underlying information within user interface data structure 164. For example, manipulation of one or more growth modules may result in a modification of the underlying information within user interface data structure 164. In some cases, user interface data structure 164 may contain the necessary information to render graphical user interface 168 wherein user interface data structure 164 may include information such as the size of GUI, the elements, to be displayed, the icons to be displayed and the like. In some cases, user interface data structure 164 may be configured to manage event handlers. For example, user interface data structure 164 may contain instructions to processor 108 to perform an action when a button or an interaction component is manipulated within GUI 168.

With continued reference to FIG. 1, user interface support module 100 may further include a display device 172 communicatively connected to at least a processor 108. “Display device” for the purposes of this disclosure is a device configured to show visual information. In some cases, display device 172 may include a liquid crystal display (LCD), a cathode ray tube (CRT), a plasma display, a light emitting diode (LED) display, and any combinations thereof. Display 1may include a display device 172. Display device 172 may include, but is not limited to, a smartphone, tablet, laptop, monitor, tablet, and the like. Display device 172 may include a separate device that includes a transparent screen configured to display computer generated images and/or information. In some cases, display may be configured to present GUI 168 to a user, wherein a user may interact with GUI 168. In some cases, a user may view GUI 168 through display 168.

With continued reference to FIG. 1, display device 172 may be configured to display the GUI 168 that has been rendered as a function of the user interface data structure 164. may be displayed on a display device 172 such as display device 172 wherein data may be viewed through the user interface. In some cases, GUI 168 may contain an interaction component. “Interaction component” for the purposes of this disclosure is a device or a computer program that is capable of allowing a user to interact with GUI 168. Interaction component may include a button or similar clickable elements wherein the clicking of the button may initiate a response or a command. In some cases, interaction component may allow a user to input attribute cluster 116, wherein interaction component may include a text box or clickable buttons that allow a user to input elements of attribute cluster 116. In some cases, interaction component may include multiple check boxes on display device 172, wherein the clicking of a checkbox may indicate to processor 108 that a specific input was entered. For example, a checking of a checkbox having the number “one” displayed on it, may indicate to processor 108 that user has entered a score of “1”. Interaction component may further contain drop down menus where a user may choose from a list of commands wherein the list of commands may perform different functions. For example, a command may include pausing or stopping the data that is being displayed. In some cases, a command may allow a user to process another iteration or go back and input more data. Interaction component may further include dialog or comment boxes wherein users may enter comments about data that is displayed. Comment boxes may be consistent with user input as described. Interaction component may further allow a user to modify or change data within attribute cluster 116 and/or one or more growth modules. In some cases, interaction component may be used to provide feedback to an operator. In some cases, interaction component may allow a user to provide feedback on any data generated by computing such that a machine learning model may be trained to provide better results.

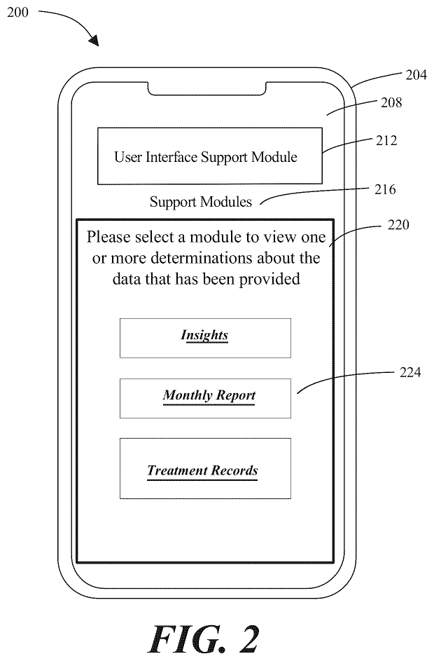

Referring now to FIG. 2, an exemplary embodiment of a GUI 200 on a display device 204 is illustrated. GUI 200 is configured to receive the user interface structure as discussed above and visualize the underlaying data within user interface data structure wherein a user may interact with data within user interface data structure. Display device 204 may include, but is not limited to, a smartphone, tablet, laptop, monitor, tablet, and the like. Display device 204 may further include a separate device that includes a transparent screen configured to display computer generated images and/or information. In some cases, GUI 200 may be displayed on a plurality of display devices. In some cases, GUI 200 may display data on separate windows 208. A “window” for the purposes of this disclosure is the information that is capable of being displayed within a border of device display. A user may navigate through different windows 208 wherein each window 208 may contain new or differing information or data. For example, a first window 208 may display information relating to attribute cluster, whereas a second window may display information relating to one or more growth modules as described in this disclosure. A user may navigate through a first second, third and fourth window (and so on) by interacting with GUI 200. For example, a user may select a button or a box signifying a next window on GUI 200, wherein the pressing of the button may navigate a user to another window. In some cases, GUI 200 may further contain event handlers, wherein the placement of text within a textbox may signify to computing device to display another window 208. An “event handler” as used in this disclosure is a callback routine that operates asynchronously once an event takes place. Event handlers may include, without limitation, one or more programs to perform one or more actions based on user input, such as generating pop-up windows, submitting forms, requesting more information, and the like. For example, an event handler may be programmed to request more information or may be programmed to generate messages following a user input. User input may include clicking buttons, mouse clicks, hovering of a mouse, input using a touchscreen, keyboard clicks, an entry of characters, entry of symbols, an upload of an image, an upload of a computer file, manipulation of computer icons, and the like. For example, an event handler may be programmed to generate a notification screen following a user input wherein the notification screen notifies a user that the data was properly received. In some embodiments, an event handler may be programmed to request additional information after a first user input is received. In some embodiments, an event handler may be programmed to generate a pop-up notification when a user input is left blank. In some embodiments, an event handler may be programmed to generate requests based on the user input. In this instance, an event handler may be used to navigate a user through various windows 208 wherein each window 208 may request or display information to or from a user. In this instance, window 208 displays an identification field 212 wherein the identification field signifies to a user, the particular action/computing that will be performed by a computing device. In this instance identification field 212 contains information stating “user interface support module” wherein a user may be put on notice that any information being received or displayed will be used to generate support modules. Identification field 212 may be consistent throughout multiple windows 212. Additionally, in this instance window 208 may display a sub identification field 216 wherein the sub identification field may indicate to a user the type of data that is being displayed or the type of data that is being received. In this instance, sub identification field 216 contains “support modules”. This may indicate to a user that computing device is displaying the information related to the support modules. Additionally, window 208 may contain a prompt 220 indicating the data that is being described in sub identification field 216 wherein prompt 220 is configured to display to a user the data that has been generated. In this instance, prompt 220 notifies a user that the user can select one of the support selection boxes 228 below to view determinations about the data provided. GUI 200 may contain selection boxes 224 wherein selection of selection box 224 may result in viewing data related to a particular selection box. For example, each selection box may contain a growth module wherein selection of a particular growth module may show a user various data to that is associated with the growth module.

With continued reference to FIG. 2, GUI 200 may be configured to receive user feedback. For example, GUI may be configured to generate support modules wherein a user may interact with GUI 200 and provide feedback on the support modules. In some cases, user feedback may be used to train a machine learning model as described above. In some cases, user feedback may be used to indicate to computing device 104 to generate another support module. In some cases, a user may determine that a support module is not a match wherein computing device 104 may determine an alternate support module. In some cases, user feedback may be used to train one or more machine learning models wherein a user may notice that a generated result may not be consistent with the information that the machine learning model received. In some cases, a user may train any machine learning model as described herein through user feedback. In some cases, user feedback may further be used to indicate to an operator of user interface support module to provide alternative support modules, to update existing support modules and/or to provide additional features associated with user interface support module 100. In some cases, user feedback may be used to generate more support modules, to upgrade existing interfaces and to reach out to an operator for help with one or more modules. In some cases, user feedback may be used such that an operator of user interface support modules 100 may be notified to aid the user in using the module.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure. As a non-limiting illustrative example inputs may include attribute cluster or a sorted attribute cluster.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to support categorizations or categorizations relating to particular medical issues.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described above as inputs, and outputs as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

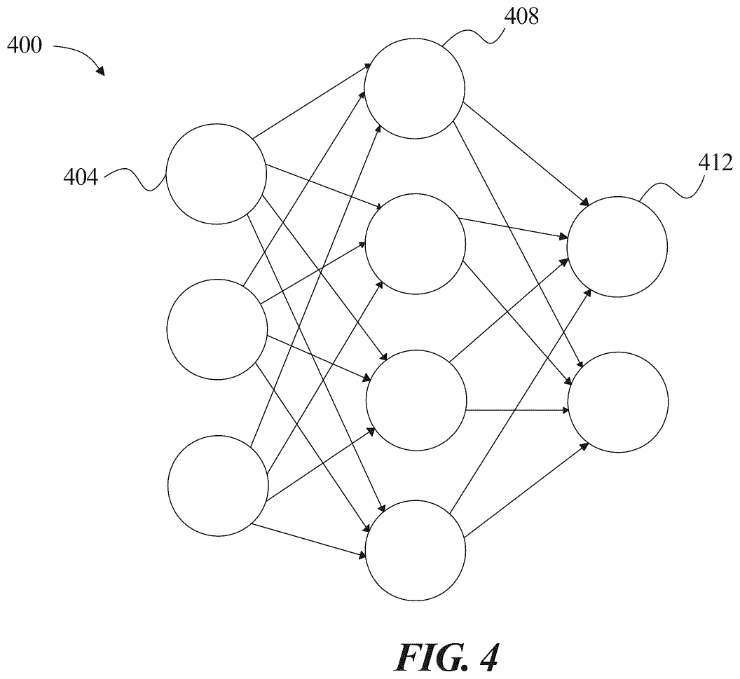

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

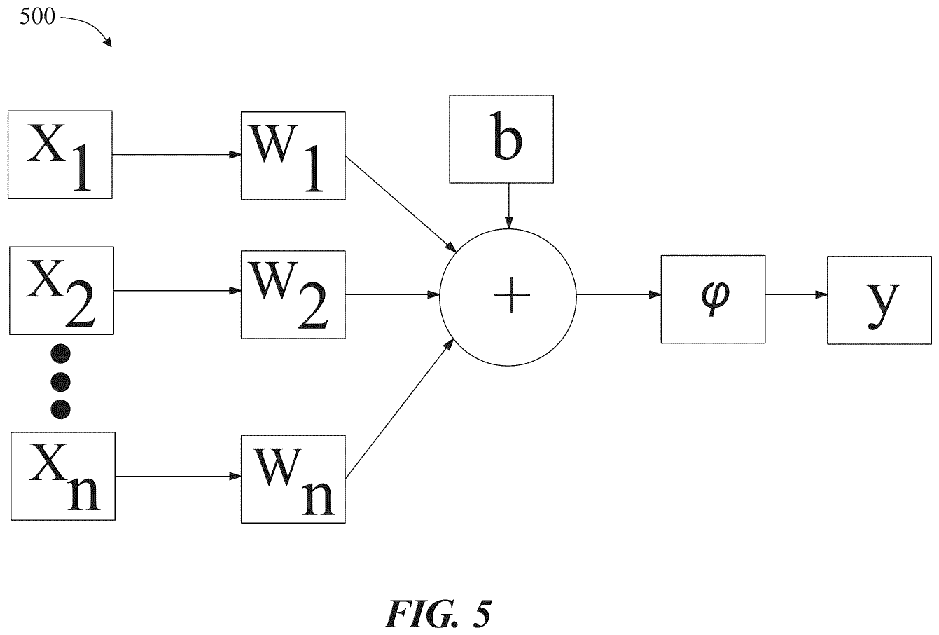

Referring now to FIG. 5, an exemplary embodiment of a node 500 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$\\ f ( x ) = \frac{1}{1 - {e}^{{}_{} - x}}$$

given input x, a tanh (hyperbolic tangent) function, of the form

$$\\ \frac{{e}^{{}_{} x} - {e}^{{}_{} - x}}{{e}^{{}_{} x} + {e}^{{}_{} - x}} ,$$

a tanh derivative function such as f(x)=tanh²(x), a rectified linear unit function such as f(x)=max (0, x), a “leaky” and/or “parametric” rectified linear unit function such as f(x)=max (ax, x) for some a, an exponential for some value of α (this function linear units function such as

$$\\ f ( x ) = \{ \begin{matrix}x for x \geq 0 \\ α ( {e}^{{}_{} x} - 1 ) for x < 0\end{matrix}$$

may be replaced and/or weighted by its own derivative in some embodiments), a softmax function such as

$$\\ f ( {x}_{i} ) = \frac{{e}^{{}_{} x}}{{\sum }_{i} {x}_{i}}$$

where the inputs to an instant layer are xᵢ, a swish function such as f(x)=x*sigmoid (x), a Gaussian error linear unit function such as f(x)=a(1+tanh(\sqrt{2/π}(x+bx^{r}))) for some values of a, b, and r, and/or a scaled exponential linear unit function such as

$$\\ f ( x ) = λ \{ \begin{matrix}α ( {e}^{{}_{} x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function q, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring to FIG. 6, an exemplary embodiment of fuzzy set comparison 600 is illustrated. A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$\\ y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$\\ y ( x , a , b , c , d ) = max ( min ( \frac{x - a}{b - a} , 1 , \frac{d - x}{d - c} ) , 0 )$$

a sigmoidal function may be defined as:

$$\\ y ( x , a , c ) = \frac{1}{1 - {e}^{{}_{} - a ( x - c )}}$$

a Gaussian membership function may be defined as:

$$\\ y ( x , c , σ ) = {e}^{{}_{} - \frac{1}{2} {( \frac{x - c}{σ} )}^{2}}$$

and a bell membership function may be defined as:

$$\\ y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 6, first fuzzy set 604 may represent any value or combination of values as described above, including output from one or more machine-learning models, attribute cluster, and a predetermined class, such as without limitation of support categorization. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 628 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between an output from one or more machine-learning models and/or attribute cluster, and a predetermined class, such as without limitation support categorization, for combination to occur as described above. Alternatively or additionally, each threshold may be tuned by a machine-learning and/or statistical process, for instance and without limitation as described in further detail below.

Further referring to FIG. 6, in an embodiment, a degree of match between fuzzy sets may be used to classify an attribute cluster with support categorization. For instance, if a support categorization has a fuzzy set matching attribute cluster fuzzy set by having a degree of overlap exceeding a threshold, computing device may classify the attribute cluster as belonging to the support categorization. Where multiple fuzzy matches are performed, degrees of match for each respective fuzzy set may be computed and aggregated through, for instance, addition, averaging, or the like, to determine an overall degree of match.

Still referring to FIG. 6, in an embodiment, an attribute cluster may be compared to multiple support categorization fuzzy sets. For instance, attribute cluster may be represented by a fuzzy set that is compared to each of the multiple support categorization fuzzy sets; and a degree of overlap exceeding a threshold between the attribute cluster fuzzy set and any of the multiple support categorization fuzzy sets may cause computing device to classify the attribute cluster as belonging to support categorization. For instance, in one embodiment there may be two support categorization fuzzy sets, representing respectively a first support categorization and a second support categorization. For example, where attribute cluster contains a particular medication and its dosage, the medication may be classified to the first support categorization and the dosage to a second. First support categorization may have a first fuzzy set; Second support categorization may have a second fuzzy set; and attribute cluster may have an attribute cluster fuzzy set. computing device, for example, may compare an attribute cluster fuzzy set with each of support categorization fuzzy set and in support categorization fuzzy set, as described above, and classify a attribute cluster to either, both, or neither of support categorization or in support categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, attribute cluster may be used indirectly to determine a fuzzy set, as attribute cluster fuzzy set may be derived from outputs of one or more machine-learning models that take the attribute cluster directly or indirectly as inputs.

Still referring to FIG. 6, a computing device may use a logic comparison program, such as, but not limited to, a fuzzy logic model to determine a support categorization response. An support categorization response may include, but is not limited to, amateur, average, knowledgeable, superior, and the like; each such support categorization response may be represented as a value for a linguistic variable representing support categorization response or in other words a fuzzy set as described above that corresponds to a degree of similarity or compatibility as calculated using any statistical, machine-learning, or other method that may occur to a person skilled in the art upon reviewing the entirety of this disclosure. In other words, a given element of attribute cluster may have a first non-zero value for membership in a first linguistic variable value such as “first score label” and a second non-zero value for membership in a second linguistic variable value such as “second score label” In some embodiments, determining a support categorization may include using a linear regression model. A linear regression model may include a machine learning model. A linear regression model may be configured to map data of attribute cluster, such as degree of match to one or more support categorization parameters. A linear regression model may be trained using a machine learning process. A linear regression model may map statistics such as, but not limited to, quality of attribute cluster compatibility. In some embodiments, determining a support categorization of attribute cluster may include using a support categorization classification model. A support categorization classification model may be configured to input collected data and cluster data to a centroid based on, but not limited to, frequency of appearance, linguistic indicators of quality, and the like. Centroids may include scores assigned to them such that quality of compatibility of attribute cluster may each be assigned a score. In some embodiments support categorization classification model may include a K-means clustering model. In some embodiments, support categorization classification model may include a particle swarm optimization model. In some embodiments, determining the support categorization of an attribute cluster may include using a fuzzy inference engine. A fuzzy inference engine may be configured to map one or more attribute cluster data elements using fuzzy logic. In some embodiments, attribute cluster may be arranged by a logic comparison program into support categorization arrangement. A “support categorization arrangement” as used in this disclosure is any grouping of objects and/or data based on skill level and/or output score. This step may be implemented as described above in FIGS. 1-6. Membership function coefficients and/or constants as described above may be tuned according to classification and/or clustering algorithms. For instance, and without limitation, a clustering algorithm may determine a Gaussian or other distribution of questions about a centroid corresponding to a given match level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 6, an inference engine may be implemented according to input and/or output membership functions and/or linguistic variables. For instance, a first linguistic variable may represent a first measurable value pertaining to attribute cluster, such as a degree of match of an element, while a second membership function may indicate a degree of in support categorization of a subject thereof, or another measurable value pertaining to attribute cluster. Continuing the example, an output linguistic variable may represent, without limitation, a score value. An inference engine may combine rules, such as: “if the difficulty level is ‘hard’ and the popularity level is ‘high’, the question score is ‘high’”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “1,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

Further referring to FIG. 6, attribute cluster to be used may be selected by user selection, and/or by selection of a distribution of output scores, such as 60% hard/expert, 40% moderate average, and 60% easy/beginner levels or the like. Each support categorization may be selected using an additional function such as in support categorization as described above.

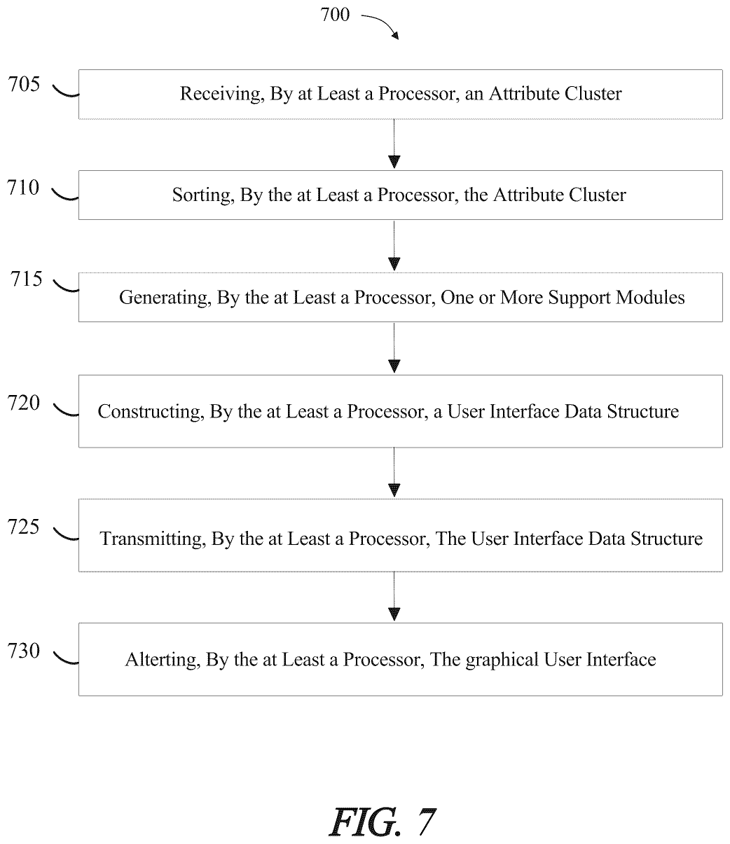

Referring now to FIG. 7, a method 700 of providing support modules through a user interface is provided. At step 705, method 700 includes receiving, by at least a processor, an attribute cluster relating to one or more treatment recipients. This step may be implemented as described above with reference to FIGS. 1-7, without limitation.

With continued reference to FIG. 7, at step 705 method 700 includes sorting, by at least the processor, the attribute cluster into one or more support categorizations. In some cases, sorting, by the at least a processor, the attribute cluster to one or more support categorizations includes classifying, by the at least a processor, the attribute cluster to one or more support categorizations using a support classifier. This step may be implemented as described above with reference to FIGS. 1-7, without limitation.

With continued reference to FIG. 7, at step 710 method 700 includes generating, by the at least a processor, one or more support modules as a function of the sorting, wherein at least one of the one or more support modules is generated as a function of a support machine learning model. In some cases generating, by the at least a processor, the one or more support modules includes comparing the attribute cluster to one or more safety thresholds. In some cases generating, by the at least a processor, the one or more support modules includes comparing the attribute cluster to one or more safety thresholds. In some cases, at least one of the one or more support modules includes information relating to treatment recipient journeys. In some cases, generating, by the at least a processor, the one or more support modules further includes receiving support training data having a plurality of attribute clusters correlated to a plurality of support modules, training the support machine learning model as a function of the support training data and generating one or more support modules as a function of the support machine learning model. In some cases, the support training data includes historical data. In some cases, the one or more support modules includes one or more insights based on one or more support categorizations. In some cases, generating, by the at least a processor, the one or more support modules as a function of the sorting includes generating the one or more support modules using a rule-based system. In some cases, generating, by the at least a processor, the one or more support modules comprises retrieving a plurality of support modules, and selecting one or more support modules from the plurality of support modules as a function of the sorting. This step may be implemented as described above with reference to FIGS. 1-7, without limitation.

With continued reference to FIG. 7, at step 715, method 700 includes constructing, by the at least a processor, a user interface data structure, wherein the user interface data structure includes the one or more support modules. This step may be implemented as described above with reference to FIGS. 1-7, without limitation.

With continued reference to FIG. 7, at step 720 method 700 includes transmitting, by the at least a processor, the user interface data structure to a graphical user interface. This step may be implemented as described above with reference to FIGS. 1-7, without limitation.

With continued reference to FIG. 7, at step 725, method 700 includes altering, by the at least a processor, a graphical user interface as a function of the user interface data structure. This step may be implemented as described above with reference to FIGS. 1-7, without limitation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

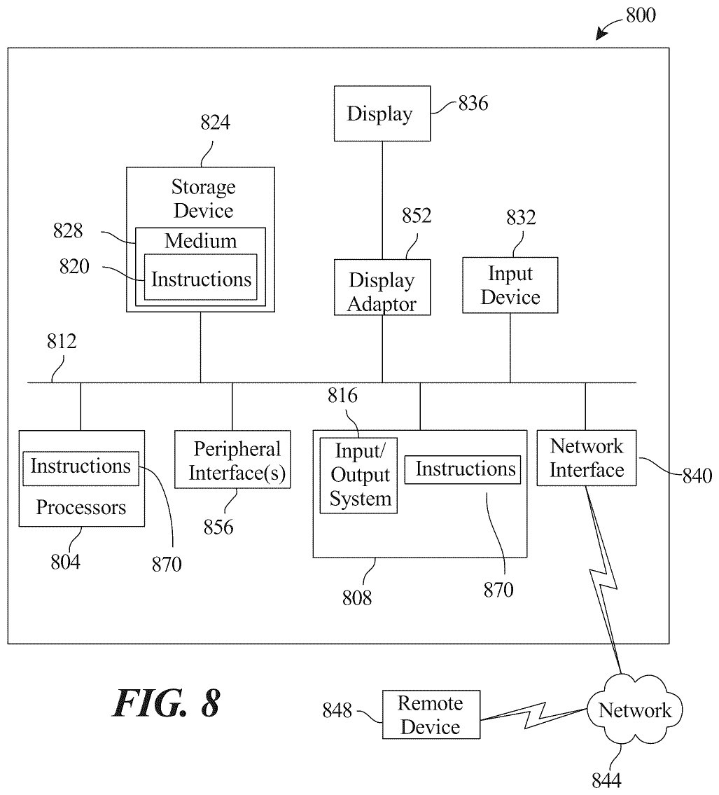

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A user interface support module, the user interface support module comprising:
at least a processor; and
a memory communicatively connected to the processor, the memory containing instructions configuring the processor to:
receive an attribute cluster relating to one or more treatment recipients;
sort the attribute cluster into one or more support categorizations;
generate one or more support modules as a function of a sorted attribute cluster using a support machine learning model, wherein generating the one or more support modules comprises:
identifying a cost associated with the sorted attribute cluster;
comparing the cost to a cost threshold; and
identifying a cost reduction tactic as a function of the comparison;
construct a user interface data structure, wherein the user interface data structure comprises the one or more support modules and one or more growth modules;
transmit the user interface data structure to a graphical user interface;
display, in the graphical user interface, an identification field containing information of the one or more support modules, wherein the identification field further comprises a plurality of prompts indicating data described in a plurality of sub identification fields, wherein one or more support selection boxes are selected as a function of the prompts, and wherein each of the one or more support selection boxes contains information associated with the one or more growth modules;
display, in the graphical user interface, the sorted attribute cluster in a first window and the one or more growth modules in a second window; and
alter the graphical user interface as a function of the user interface data structure, the one or more support selection boxes selected, and the one or more growth modules selected.

2. The user interface support module of claim 1, wherein sorting the attribute cluster to one or more support categorizations comprises classifying the attribute cluster to one or more support categorizations using a support classifier.

3. The user interface support module of claim 1, wherein generating the one or more support modules comprises comparing the attribute cluster to one or more safety thresholds.

4. The user interface support module of claim 3, wherein at least one of the one or more support modules includes information relating to a treatment recipient journey.

5. The user interface support module of claim 1, wherein generating the one or more support modules further comprises:
receiving support training data comprising a plurality of attribute clusters correlated to a plurality of support modules;
training the support machine learning model as a function of the support training data; and
generating one or more support modules as a function of the support machine learning model.

6. The user interface support module of claim 5, wherein the support training data comprises historical data.

7. The user interface support module of claim 1, wherein the one or more support modules comprises one or more insights based on the one or more support categorizations.

8. The user interface support module of claim 1, wherein the one or more support modules comprises treatment records.

9. The user interface support module of claim 1, wherein generating the one or more support modules as a function of the sorting comprises generating the one or more support modules using a rule-based system.

10. The user interface support module of claim 1, wherein generating the one or more support modules comprises:
retrieving a plurality of support modules; and
selecting one or more support modules from the plurality of support modules as a function of the sorting.

11. A method of providing support modules through a user interface, the method comprising:
receiving, by at least a processor, an attribute cluster relating to one or more treatment recipients;
sorting, by at least the processor, the attribute cluster into one or more support categorizations;
generating, by the at least a processor, one or more support modules as a function of a sorted attribute cluster using a support machine learning model, wherein generating the one or more support modules comprises:
identifying a cost associated with the sorted attribute cluster;
comparing the cost to a cost threshold; and
identifying a cost reduction tactic as a function of the comparison;
constructing, by the at least a processor, a user interface data structure, wherein the user interface data structure comprises the one or more support modules and one or more growth modules;
transmitting, by the at least a processor, the user interface data structure to a graphical user interface;
displaying, in the graphical user interface, an identification field containing information of the one or more support modules, wherein the identification field further comprises a plurality of prompts indicating data described in a plurality of sub identification fields, wherein one or more support selection boxes are selected as a function of the prompts, and wherein each of the one or more support selection boxes contains information associated with the one or more growth modules;
displaying, in the graphical user interface, the sorted attribute cluster in a first window and the one or more growth modules in a second window; and
altering, by the at least a processor, the graphical user interface as a function of the user interface data structure, the one or more support selection boxes selected, and the one or more growth modules selected.

12. The method of claim 11, wherein sorting, by the at least a processor, the attribute cluster to one or more support categorizations comprises classifying, by the at least a processor, the attribute cluster to one or more support categorizations using a support classifier.

13. The method of claim 11, wherein generating, by the at least a processor, the one or more support modules comprises comparing the attribute cluster to one or more safety thresholds.

14. The method of claim 13, wherein at least one of the one or more support modules includes information relating to treatment recipient journeys.

15. The method of claim 11, wherein generating, by the at least a processor, the one or more support modules further comprises:
receiving support training data comprising a plurality of attribute clusters correlated to a plurality of support modules;
training the support machine learning model as a function of the support training data; and
generating one or more support modules as a function of the support machine learning model.

16. The method of claim 15, wherein the support training data comprises historical data.

17. The method of claim 11, wherein the one or more support modules comprises one or more insights based on one or more support categorizations.

18. The method of claim 11, wherein the one or more support modules comprises treatment records.

19. The method of claim 11, wherein generating, by the at least a processor, the one or more support modules as a function of the sorting comprises generating the one or more support modules using a rule-based system.

20. The method of claim 11, wherein generating, by the at least a processor, the one or more support modules comprises:
retrieving a plurality of support modules; and
selecting one or more support modules from the plurality of support modules as a function of the sorting.
